(19) United States
(12) Patent Application Publication
(10) Pub. No.: US 2026/0278065 A1
(43) Pub. Date: Sep. 17, 2026

(54) Electronic avionics equipment with receiving port(s) using authentication of origin, related avionics communication installation

(71) Applicants: THALES, Meudon (FR); UNIVERSITÉ DE BORDEAUX, BORDEAUX (FR); INSTITUT POLYTECHNIQUE DE BORDEAUX, TALENCE (FR); Centre national de la recherche scientifique, PARIS (FR)

(72) Inventors: Stéphane MONNIER, MERIGNAC (FR); Toufik AHMED, TALENCE (FR)

(21) Appl. No.: 19/567,695

(22) Filed: Mar. 16, 2026

(30) Foreign Application Priority Data
Mar. 17, 2025 (FR) FR2502674

(51) Int. Cl. G06F 21/44

(52) U.S. Cl. CPC G06F 21/44

(57) ABSTRACT

Electronic avionics equipment is configured to be onboard an aircraft, the equipment including a set of communication port(s) for transmission, called transmitter port(s), and communication port(s) for receipt, called receiver port(s). At least one receiver port is switchable between a blocked state, wherein the data received by the port is automatically erased, and an unblocked state, wherein the data received by the port is stored for later processing. The equipment includes a security module configured to switch a respective receiver port from its blocked state to its unblocked state for a predefined transmitter equipment group after receiving a valid authentication message issued by the transmitter equipment group in response to an authentication request sent to the group by the security module.

### CROSS-REFERENCE TO RELATED APPLICATIONS

This application is a U.S. non-provisional application claiming the benefit of French Application No. 25 02674, filed on Mar. 17, 2025, which is incorporated herein by reference in its entirety.

### FIELD

This invention relates to electronic avionics equipment configured to be embedded onboard an aircraft.

The invention also relates to an avionics communication installation configured to be embedded onboard an aircraft, comprising a plurality of electronic avionics equipment interconnected.

The invention relates to the field of cybersecurity, particularly in the avionics domain.

### BACKGROUND

The different domains of an aircraft, such as the ACD (Aircraft Control Domain), AISD (Airline Information System Domain), and PIESD (Passenger Information and Entertainment Systems Domain) according to the ARINC 811 standard of Dec. 20, 2005, do not have the same levels of impact on flight safety in case of malfunction. The ACD domain is the most critical, and the PIESD domain has the least impact.

When exchanges occur between the domains, a security gateway is integrated into the aircraft to ensure that one domain cannot disrupt another domain.

Within the same domain, all computers are arbitrarily declared trustworthy. However, for the in-depth defense recommended to increase system resilience against a cyber threat, it is necessary to consider that the perimeter defense may be bypassed one day, either by finding a flaw in the gateways responsible for processing and eliminating suspicious flows or by undermining the organizational means put in place to ensure that the computers are neither modified nor replaced. In this case, the paradigm according to which all computers of the same domain are trustworthy will fall.

### SUMMARY

The purpose of the invention is then to propose an additional security mechanism aimed at ensuring the authenticity of data received.

To this end, the invention relates to electronic avionics equipment configured to be embedded onboard an aircraft, the equipment comprising a set of communication port(s) for transmission, called transmitter port(s), and communication port(s) for receipt, called receiver port(s), at least one receiver port being switchable between a blocked state, wherein the data received by said port is automatically erased, and an unblocked state, wherein the data received by said port is stored for later processing, and the equipment further comprising a security module configured to switch a respective receiver port from its blocked state to its unblocked state for a predefined transmitter equipment group, after receiving a valid authentication message issued by the transmitter equipment group in response to an authentication request sent to said group by the security module.

With the electronic avionics equipment according to the invention, for the receiver port(s), switchable between the blocked state and the unblocked state, the data storage for later processing, typically for transmission to a software application executed on the electronic avionics equipment, is then performed only if the transmitter equipment group that issued this data has been previously authenticated by the avionics equipment according to the invention. These ports, switchable between the blocked state and the unblocked state, are also called ports using authentication of origin. Indeed, in the absence of such authentication, each corresponding port remains in the blocked state for the transmitter equipment group concerned, and, if applicable, the data received from said group is erased automatically upon receipt thereof by said receiver port.

According to other advantageous aspects of the invention, the electronic avionics equipment comprises one or more of the following features, taken individually or in any technically possible combinations:
when the equipment is powered on, the security module is configured to initialize each respective receiver port to its unblocked state for a predefined initialization duration; then, upon expiration of the initialization duration, to automatically switch each receiver port that has not received a valid authentication message from its unblocked state to its blocked state;
the security module is configured to regularly send the authentication request to the transmitter equipment group associated with the respective receiver port;
the security module preferably being configured to send the authentication request to said group according to a predefined emission period;
the predefined initialization duration is greater than the predefined emission period;
the predefined initialization duration preferably being equal to a multiple of the predefined emission period, the multiple being an integer greater than or equal to two;
if a connection between the equipment and the predefined transmitter equipment group is made via a network switch, then the security module is configured to switch a respective receiver port from its blocked state to its unblocked state for said group only after receiving both a first valid authentication message, issued by said group in response to a first authentication request sent to said group, and a second valid authentication message, issued by the network switch in response to a second authentication request sent to the network switch;
the security module is configured to send the authentication request to a single transmitter equipment of the group;
if the transmitter equipment group includes multiple transmitter equipment, then the security module is configured to send the authentication request to the transmitter equipment unit acting as a proxy for the other equipment of the group;
the authentication request contains an identifier of the transmitter equipment to which said request is intended, a first random number, an identifier of said request, and an identifier of a signature algorithm to be applied; and
in response to an authentication request received, containing the identifier of the emitting equipment, the first random number, the request identifier and the algorithm identifier—the authentication message generated by the transmitter equipment contains a second random number, a signature and said request identifier; the signature being obtained by applying the signature algorithm corresponding to the algorithm identifier—to a concatenation of the identifier of the emitting equipment, the first random number, the request identifier and the second random number; and the security module is configured to verify the signature contained in an authentication message received in response to a previously sent authentication request and then determine the authentication message as valid if the signature is correct and as invalid if the signature is incorrect, respectively.

The invention also relates to an avionics communication installation configured to be embedded onboard an aircraft, the installation comprising a plurality of interconnected electronic avionics equipment, with at least one item of the equipment being as defined above.

### BRIEF DESCRIPTION OF THE DRAWINGS

These features and advantages of the invention will become clearer upon reading the following description, given solely as a non-limiting example, and made with reference to the attached drawings, wherein:

FIG. 1 is a schematic representation of an aircraft according to the invention comprising a communication installation compartmentalized into an avionics domain and an open domain, external to the avionics domain; the communication installation comprising multiple avionics systems belonging to the avionics domain, one or more electronic devices belonging to the open domain and an electronic communication gateway connected between the electronic devices and the avionics systems, at least one among the avionics systems and the electronic devices forming an item of electronic avionics equipment according to the invention; and

FIG. 2 is a schematic representation of the communication installation according to the invention, the installation including a plurality of interconnected electronic avionics equipment, the equipment being avionics systems, or electronic devices, or a mix of avionics systems and electronic devices from FIG. 1; at least one item of the equipment being equipment according to the invention with at least one port using authentication of origin, said port being switchable from a blocked state to an unblocked state after receiving a valid authentication message for a transmitter equipment unit group in response to an authentication request sent to said group;

FIG. 3 is a representation of the different fields forming the authentication request and the respective authentication message generated in response by the transmitter equipment concerned; and

FIG. 4 is a view illustrating a sequence of messages exchanged between the equipment according to the invention and a transmitter equipment unit.

### DETAILED DESCRIPTION

The expressions “substantially equal to” and “of the order of” define an equality relationship of plus or minus 20%, preferably plus or minus 10%, and more preferably plus or minus 5%.

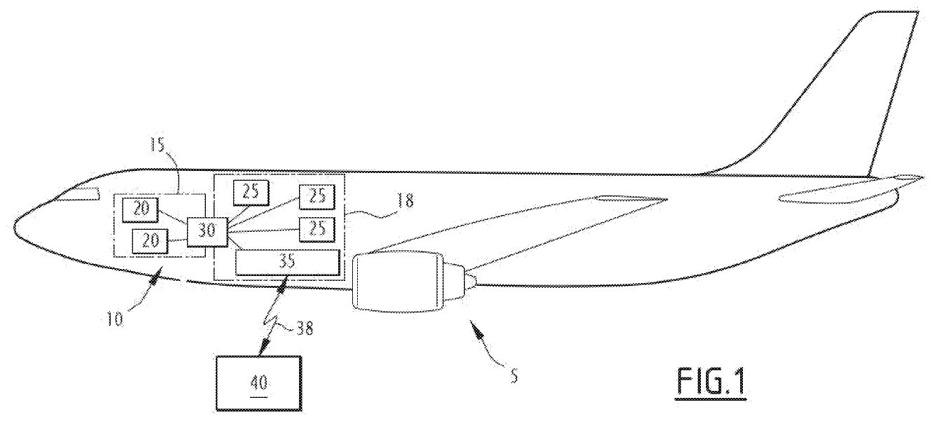

In FIG. 1, an aircraft 5 comprises a communication installation 10, compartmentalized into an avionics domain 15 and an open domain 18, external to the avionics domain 15.

The communication installation 10 includes multiple avionics systems 20 belonging to the avionics domain 15, as well as one or more electronic devices 25, external to the avionics domain 15 and belonging to the open domain 18.

In the example of FIG. 1, the communication installation 10 includes an electronic communication gateway 30 connected between the electronic devices 25 and the avionics systems 20. In the example of FIG. 1, the communication installation 10 includes multiple electronic devices 25, each belonging to the open domain 18.

Additionally, the communication installation 10 further comprises a communication server 35 communicating with at least one electronic station 40 external to the aircraft 5 via a communication link 38.

The avionics domain 15 is a domain corresponding to the highest security level onboard the aircraft 5, particularly the highest required security level of the communication installation 10 of the aircraft 5.

The avionics domain 15 is then a domain to limit the risk of disruption—by at least one communication with an electronic device or device external to the avionics domain 15—of function(s) implemented by the at least one avionics system 20 of the avionics domain 15. The avionics domain 15 comprises the avionics system(s) 20.

The avionics domain 15 is typically the ACD domain (Aircraft Control Domain) according to the ARINC 811 standard of Dec. 20, 2005.

The open domain 18 is a domain corresponding to a security level lower than the security level of the avionics domain 15. The open domain 18 comprises the electronic devices 25.

Each avionics system 20 is embedded onboard the aircraft 5 and belongs to the avionics domain 15. Each avionics system 20, also called an avionics computer, is known per se and is configured to implement one or more respective avionics functions.

Each avionics system 20 is, for example, chosen from the group consisting of: a flight management system, also called FMS (Flight Management System); a guidance system, or FG (Flight Guidance); a flight control system, or FCS (Flight Control System); a satellite positioning system GNSS (Global Navigation Satellite System), such as a GPS system (Global Positioning System); an inertial reference system, also called IRS (Inertial Reference System); an instrument landing system ILS (Instrument Landing System) or a microwave landing system MLS (Microwave Landing System); an active runway overrun prevention system, also called ROPS (Runway Overrun Prevention System); and a radio altimeter, also noted RA (Radio Altimeter).

The electronic communication gateway 30 interfaces between the open domain 18 and the avionics domain 15. A data message transmitted between the open domain 18 and the avionics domain 15, i.e. from the open domain 18 to the avionics domain 15, or vice versa, from the avionics domain 15 to the open domain 18, necessarily transits through the communication gateway 30.

The communication server 35 is configured to communicate via the communication link 38 with at least one external electronic station 40, said at least one external station 40 being a ground station or a cloud computing station, for example. The communication server 35 is preferably connected to the communication gateway 30. The communication server 35 typically belongs to the open domain 18.

The communication server 35 is known per se and specifically includes a transceiver, not shown, compatible with the communication link 38. The communication link 38 is typically a radio link, i.e. a link by radio waves such as a satellite link. The transceiver is thus a radio transceiver.

The external station 40 is typically connected to an IT infrastructure of an operational control center, also called OCC (Operational Control Center). The external station 40 is then advantageously configured to transmit data to the communication installation 10, such as a flight plan of the aircraft 5 and information related to the aircraft 5 such as its mass, configuration, balance, or its identifier.

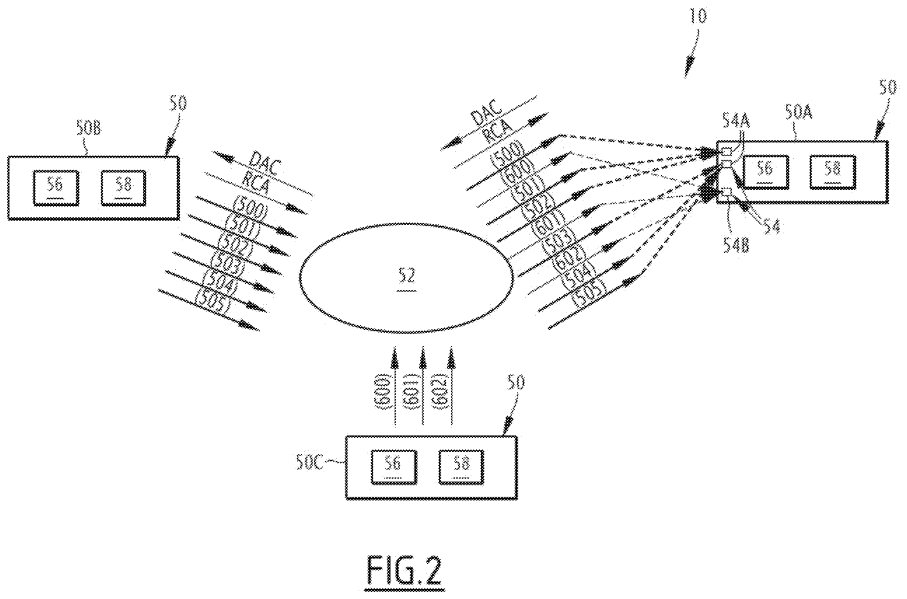

In FIG. 2, the communication installation 10, represented in a simplified manner, comprises multiple interconnected electronic avionics equipment 50, called avionics equipment 50 hereafter. In the example of FIG. 2, the multiple avionics equipment 50 is interconnected via a network switch 52 (switch). In a variant, not shown, the multiple avionics equipment 50 is interconnected via point-to-point links.

The avionics equipment 50 is avionics systems 20 belonging to the avionics domain 15, or electronic devices 25 belonging to the open domain 18, or a set of avionics equipment 50 is a mix of avionics systems 20 and electronic devices 25.

Each item of avionics equipment 50 according to the invention comprises a set of communication port(s) for transmission, called transmitter port(s), and communication port(s) for receipt, called receiver port(s). In the example of FIG. 2, one item of the avionics equipment, also called first avionics equipment 50A, comprises multiple bidirectional communication ports 54, each bidirectional communication port 54 then being able to transmit data and receive data.

According to the invention, at least one receiver port of the avionics equipment 50A is switchable between a blocked state, wherein the data received by said port is automatically erased, and an unblocked state, wherein the data received by said port is stored for later processing.

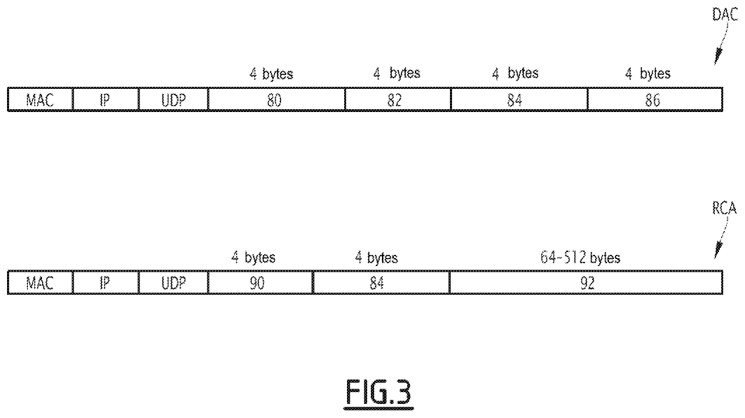

The avionics equipment 50A according to the invention further comprises a security module 56, configured to switch a respective receiver port from its blocked state to its unblocked state for a predefined transmitter equipment group after receiving a valid CRA authentication message issued by the transmitter equipment group, in response to a CAR authentication request sent to said group by the security module 56. The CRA authentication message and the CAR notification request are visible in FIG. 3 and will be described in more detail later.

Each receiver port that is switchable from its blocked state to its unblocked state after receiving a respective valid CRA authentication message is also called a port using authentication of origin, also noted as DAO (Data Authentication of Origin) port. In the example of FIG. 2, the first avionics equipment 50A comprises a set of DAO port(s) and a set of normal port(s), i.e. not switchable between the blocked state and the unblocked state; and each DAO port is noted 54A, with each normal port being noted 54B.

Advantageously, the avionics equipment 50A according to the invention further comprises a processing module 58, configured to process the data received by the receiver port(s). The processing module 58 is thus configured to process the data received by the DAO port(s) that are in their unblocked state, as well as to process all the data received by the normal port(s). The processing module 58 typically includes one or more software applications, executed to perform the said processing.

In the example of FIG. 2, each item of avionics equipment 50 comprises a set of DAO port(s), the security module 56 and, advantageously, the processing module 58. Each item of avionics equipment 50 of the communication installation 10 is then preferably configured to implement the invention. In the example of FIG. 2, for simplicity of the drawing, the communication ports are not represented for the avionics equipment 50 other than the first item of avionics equipment 50A, i.e. not for a second item of avionics equipment 50B and a third item of avionics equipment 50C.

At least one item of avionics equipment 50, and preferably each item of avionics equipment 50, comprises an information processing unit, for example, typically formed of a memory and a processor associated with the memory, not shown.

According to this example, the acquisition module 56 and the processing module 58 are each implemented as software, or a software brick, executable by the processor. The memory of the respective avionics equipment 50 is then able to store security software and processing software. The processor of the respective avionics equipment 50 is then able to execute each program of the security software and the processing software.

In a variant, not shown, the acquisition module 56 and the processing module 58 are each implemented as a programmable logic component such as an FPGA (Field Programmable Gate Array), or an integrated circuit such as an ASIC (Application Specific Integrated Circuit).

When at least one item of avionics equipment 50, and preferably each item of avionics equipment 50, is implemented as one or more computer programs, i.e. as software, also called a computer program product, it is also able to be recorded on a medium, not shown, readable by a computer. The computer-readable medium is a medium able to store electronic instructions and to be coupled to a bus of a computer system, for example. For example, the readable medium is an optical disk, a magneto-optical disk, a ROM memory, a RAM memory, any type of non-volatile memory (such as EPROM, EEPROM, FLASH, NVRAM), a magnetic card, or an optical card. A computer program comprising software instructions is then stored on the readable medium.

In FIG. 2, the numbers indicated in parentheses, namely (500) to (505) and (600) to (602), correspond to message numbers. Messages (500) to (505) are messages issued by the second avionics equipment 50B, acting as transmitter equipment that must authenticate, with the first avionics equipment 50A, particularly its security module 56, with the messages (500) to (505) of the second avionics equipment 50B being received by a DAO port 54A of the first avionics equipment 50A. The messages (600) to (602) are messages issued by the third avionics equipment 50C, acting as another item of transmitter equipment that does not need to authenticate, with the first avionics equipment 50A, the messages (600) to (602) of the third avionics equipment 50C being received by a normal port 54B of the first avionics equipment 50A.

The security module 56 is configured to switch a respective receiver port from its blocked state to its unblocked state for a predefined transmitter equipment group only after receiving a valid CRA authentication message issued by the transmitter equipment group.

The security module 56 is configured to send the CAR authentication request to a single transmitter equipment 50, 50B of the group, for example.

As an optional complement, if the transmitter equipment group 50, 50B includes multiple transmitter equipment, then the security module 56 is configured to send the CAR authentication request to a transmitter equipment unit acting as a proxy for the other equipment of the group.

According to a first advantageous aspect, upon powering on the respective avionics equipment 50 implementing the invention, such as the first avionics equipment 50A in FIG. 2, the security module 56 is configured to initialize each respective receiver port to its unblocked state for a predefined initialization duration T0. Upon expiration of the initialization duration, the security module 56 is then further configured to automatically switch each receiver port that has not received a valid CRA authentication message during said initialization duration from its unblocked state to its blocked state.

The predefined initialization duration T0 is between 30 seconds and two minutes, for example, preferably between 45 seconds and 90 seconds, and more preferably substantially equal to 60 seconds.

According to a second advantageous aspect, the security module 56 is configured to regularly send the CAR authentication request to the transmitter equipment group 50, 50B associated with the respective receiver port 54A.

According to this second advantageous aspect, the security module 56 is configured to send the CAR authentication request to said group according to a predefined emission period T1, for example.

According to this second advantageous aspect, the initialization duration T0 is typically greater than the emission period T1. The initialization duration T0 is equal to a multiple of the emission period T1, for example, with the multiple being an integer greater than or equal to two.

The emission period T1 is between 5 seconds and 15 seconds, for example, and preferably substantially equal to 10 seconds.

According to a third advantageous aspect, if a connection between the equipment 50, 50A and the predefined transmitter equipment group 50, 50B is made via the network switch 52, then the security module 56 is configured to switch a respective DAO port 54A from its blocked state to its unblocked state for said group only after receiving both a first valid CRA authentication message, issued by said group in response to a first CAR authentication request sent to said group, and a second valid CRA authentication message, issued by the network switch 52 in response to a second CAR authentication request sent to the network switch 52.

In FIG. 3, the CAR authentication request contains an identifier 80 of a transmitter equipment unit 50, 50B to which said CAR request is intended, also called the first identifier 80; a first random number 82; an identifier 84 of said CAR request, also called the second identifier 84; and an identifier 86 of a signature algorithm to be applied, also called the third identifier 86.

In the example of FIG. 3, the CAR authentication request also contains a header including MAC (Media Access Control), IP (Internet Protocol), and UDP (User Datagram Protocol) fields. As known per se, the MAC field typically contains a MAC address, i.e. a unique physical address assigned to a network interface, generally used in the data link layer (layer 2 of the OSI model) for identifying equipment on a local network. The IP field typically contains a logical address, enabling identifying equipment on an interconnected network, generally used in the network layer (layer 3 of the OSI model) to route packets between different networks. The UDP field typically contains an indication of a transport protocol, enabling sending data in the form of a datagram without prior connection, generally used in the transport layer (layer 4 of the OSI model).

In response to a CAR authentication request received containing the identifier 80 of the transmitter equipment 50, 50B, the first random number 82, the identifier 84 of the CAR request and the identifier 86 of the algorithm—the CRA authentication message generated by the transmitter equipment 50, 50B contains a second random number 90, a signature 92, and said request identifier 84, as also represented in FIG. 3.

In the example of FIG. 3, the CRA authentication message also contains the header including the MAC, IP, and UDP fields.

In the example of FIG. 3, byte sizes of each of the fields of the useful part of the CAR authentication request and of the respective CRA authentication message are indicated as an example. According to this example, the size for each of the first identifier 80, the first random number 82, the second identifier 84 and the third identifier 86 is four bytes. The size of the second random number 90 is also four bytes, for example, and the size of the signature 92 is typically between 64 and 512 bytes.

The signature 92 is obtained by applying the signature algorithm corresponding to the third identifier 86 to a concatenation of the identifier 80 of the transmitter equipment 50, 50B, the first random number 82, the identifier 84 of the CAR request, and the second random number 90. In other words, the signature 92 is obtained by applying the signature algorithm defined by the third identifier 86 to the concatenation of the first identifier 80, the first random number 82, the second identifier 84 and the second random number 90.

The security module 56 is then configured to verify the signature 92 contained in an CRA authentication message received in response to a previously sent CAR authentication request and then determine the CRA authentication message as valid if the signature 92 is correct and as invalid if the signature 92 is incorrect, respectively.

The signature algorithm is, for example, chosen from the group comprising: an HMAC algorithm (Hash-based Message Authentication Code), also called SHA-256 (Secure Hash Algorithm 256 bits); an RSA algorithm (Rivest, Shamir, and Adleman) with a 2048-bit key; an RSA algorithm with a 4096-bit key; an ECDSA algorithm (Elliptic Curve Digital Signature Algorithm); and an EdDSA algorithm (Edwards-Curve Digital Signature Algorithm).

According to this example, the value contained in the third identifier 86 used to identify the signature algorithm to be used is, for example, equal to 0 for the HMAC algorithm; 1 for the RSA-2048 algorithm; 2 for the RSA-4096 algorithm; 3 for the ECDSA algorithm; and 4 for the EdDSA algorithm.

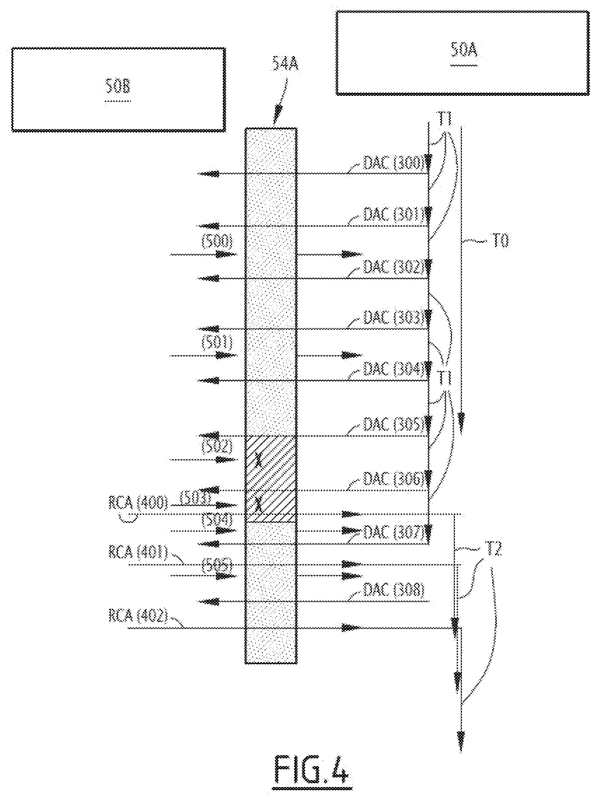

Thus, the avionics equipment 50 according to the invention, such as the first avionics equipment 50A in the example of FIGS. 2 and 4, is configured to only forward the data to the processing module 58 after receiving proof that the transmitter equipment possesses a secret allowing it to be authenticated.

The property of a receipt port being DAO or not is typically static information also linked to the operating mode of the equipment. For example, in the so-called data loading mode, it is necessary to allow the update of the avionics equipment 50, which may require the temporary loss of the DAO property of a port to avoid a blocking situation.

The DAO receipt ports 54A are grouped by cluster associated with the partition of a transmitter equipment unit of the received data, for example. The transmitting partition is software running on an IMA platform (Integrated Modular Avionics), for example, i.e. an integrated modular avionics platform, or a main software of equipment. An IMA platform hosts multiple partitions with different DAL (Development Assurance Level) levels of criticality, for example.

As described previously, the DAO receipt ports 54A have two possible states, namely the unblocked state, corresponding to a state wherein the respective DAO receipt port 54A operates normally, and the blocked state, corresponding to the state wherein the respective DAO receipt port 54A no longer stores the received data, which are permanently lost after their receipt.

The transition from the blocked state to the unblocked state of a respective DAO port 54A or the DAO ports 54A of the cluster follows the sending of the CAR authentication request (for Challenge Authentication Request), such as the successive requests (300) to (308) in FIG. 4, issued by the avionics equipment 50 according to the invention, such as the first avionics equipment 50A, to respective transmitter avionics equipment such as the second avionics equipment 50B; then, upon receiving the CRA authentication message (for Challenge-Response Authentication), such as the successive authentication messages (400) to (402) in FIG. 4 corresponding to (400) issued by the transmitter equipment to the avionics equipment according to the invention, the transition to the unblocked state being then performed after verifying the validity of the received CRA authentication message compared to the sent CAR authentication request.

The skilled person will observe that the receipt ports associated with CAR/CRA exchanges initially do not have the DAO port property and are then initially unblocked so that this CAR/CRA exchange mechanism is possible.

Upon switching to an operational mode, after starting the avionics equipment 50 according to the invention, the DAO ports 54A are then in the unblocked state during the predefined initialization duration T0.

In parallel, the avionics equipment 50 according to the invention, such as the first avionics equipment 50A, periodically sends, with the emission period T1, a CAR authentication request to the respective transmitter avionics equipment such as the second avionics equipment 50B, specifically to its partition originating the received data, by the DAO port 54A or the cluster of DAO ports 54A.

Upon expiration of the initialization duration T0, if the avionics equipment 50 according to the invention has not received any valid CRA authentication message corresponding to the last sent CAR authentication request, the respective DAO port 54A or the DAO ports 54A of the cluster switch to the blocked state.

Advantageously, upon each receipt of a valid CRA authentication message corresponding to the last CAR authentication request sent by the avionics equipment 50 according to the invention, a predefined timeout T2 is reset. Upon expiration of the timeout T2, the respective DAO port 54A or the DAO ports 54A of the cluster will switch to the blocked state.

The timeout T2 is greater than the emission period T1. The timeout T2 is equal to a multiple of the emission period T1, for example, with the multiple being an integer greater than or equal to two, preferably two.

The timeout T2 is between 10 seconds and 30 seconds, for example, and preferably substantially equal to 20 seconds.

In FIG. 4, after switching to the operational mode of the avionics equipment 50 according to the invention, such as the first avionics equipment 50A, CAR authentication requests noted successive (300) to (308) are sent successively every emission period T1 to the respective transmitter equipment, such as the second avionics equipment 50B. The DAO ports of the avionics equipment 50 according to the invention are then in the unblocked state. The messages (500) and (501) can be received in the DAO ports 54A of the avionics equipment 50 according to the invention.

At the end of the initialization duration T0, with none of the CAR authentication requests (300) to (305) having received a response, the associated DAO ports 54A switch to the blocked state, as represented by the hatched area in FIG. 4. From then on, no message received in the associated DAO ports 54A is stored, these being deleted after receipt. In the example of FIG. 4, the message (502) is eliminated without being processed later by the processing module 58, for example.

Then, in the example of FIG. 4, the avionics equipment 50 according to the invention sends a new CAR notification request (306). The message (503) arrives after the emission of said CAR notification request (306), but before the receipt of the corresponding CRA authentication message (400), and is therefore eliminated, as the associated DAO ports 54A are still in the blocked state.

Then, the avionics equipment 50 according to the invention receives the valid CRA authentication message (400) corresponding to the CAR notification request (306), and the respective DAO port 54A or the DAO ports 54A of the cluster then switch to the unblocked state, the following messages (504) and (505) are then received by the associated DAO ports 54A, then stored for their internal processing by the processing module 58.

The invention enables the coexistence on the same aircraft 5 of avionics equipment 50 with DAO ports 54A with other avionics equipment 50 not having this capability.

The invention can advantageously be added to an existing solution, by adding this mechanism according to the invention in parallel with a communication solution between avionics equipment 50 already in place.

In a communication installation 10 where some avionics equipment 50 may take multiple tens of seconds to start and others a few seconds, the invention also allows prioritizing the transmission of information first without requiring authentication of the transmitter equipment, which will be deferred.

In the case of untrusted equipment bombarding legitimate equipment with malicious data, the blocked state property of a respective DAO port 54 allows the processing module 58 not to waste time reading a port with suspicious data, as it comes from equipment that has not responded to the CAR authentication requests.

Furthermore, with the processing according to the invention being performed in parallel, the invention does not disrupt existing real-time by not adding processing time before the emission or after the receipt of each message.

Moreover, the invention does not disrupt maintenance operations, with the DAO property of each respective port 54A able to be deactivated for certain modes of the aircraft 5 such as a ground mode or a data loading mode, for example.

Furthermore, the invention is deployable in stages, with limited impact on the avionics equipment 50. For example, initially, only some transmitter equipment will be able to respond to CAR authentication requests issued by the equipment according to the invention. The fact that a third equipment, such as the third equipment 50C in FIG. 2, does not respond to the CAR authentication requests is then processed, for example, by assigning a sufficiently large value not to be reached at the initialization duration T0 for the associated DAO ports 54A for the data received from said third equipment. Later, when the third equipment is able to respond to the CAR authentication requests, it will then suffice to reposition the initialization duration T0 to a nominal value, such as 60 seconds, for the associated DAO ports 54A for the data received from said third equipment.

The invention relates to all types of avionics communication, specifically Ethernet, ARINC 664 part 3, ARINC 664 part 7, and TSN communications.

It is thus understood that the avionics equipment 50 according to the invention enables proposing an additional security mechanism aimed at ensuring the authenticity of the data received.

1. Avionics electronic equipment configured to be embedded onboard an aircraft, the equipment comprising a set of communication port(s) for transmission, called transmitter port(s), and communication port(s) for receipt, called receiver port(s),
wherein at least one receiver port is switchable between a blocked state, wherein the data received by said port is automatically erased, and an unblocked state, wherein the data received by said port is stored for later processing, and
wherein the equipment further comprises a security module configured to switch a respective receiver port from its blocked state to its unblocked state for a predefined transmitter equipment group, after receiving a valid authentication message issued by the transmitter equipment group, in response to an authentication request sent to said group by the security module.

2. The equipment according to claim 1, wherein, upon powering on the equipment, the security module is configured to initialize each respective receiver port to its unblocked state for a predefined initialization duration; then, upon expiration of the initialization duration, to automatically switch each receiver port that has not received a valid authentication message from its unblocked state to its blocked state.

3. The equipment according to claim 1, wherein the security module is configured to regularly send the authentication request to the transmitter equipment group associated with the respective receiver port.

4. The equipment according to claim 3, wherein the security module is configured to send the authentication request to said group according to a predefined emission period.

5. The equipment according to claim 2, wherein the security module is configured to regularly send the authentication request to the transmitter equipment group associated with the respective receiver port, and
wherein the predefined initialization duration is greater than the predefined emission period.

6. The equipment according to claim 5, wherein the predefined initialization duration is equal to a multiple of the predefined emission period, with the multiple being an integer greater than or equal to two.

7. The equipment according to claim 1, wherein if a connection between the equipment and the predefined transmitter equipment group is made via a network switch, then the security module is configured to switch a respective receiver port from its blocked state to its unblocked state for said group only after receiving both a first valid authentication message issued by said group in response to a first authentication request sent to said group and a second valid authentication message issued by the network switch, in response to a second authentication request sent to the network switch.

8. The equipment according to claim 1, wherein the security module is configured to send the authentication request to a single transmitter equipment of the group.

9. The equipment according to claim 1, wherein if the transmitter equipment group includes multiple transmitter equipment, then the security module is configured to send the authentication request to a transmitter equipment unit acting as a proxy for the other equipment of the group.

10. The equipment according to claim 1, wherein the authentication request contains an identifier of a transmitter equipment unit to which said request is intended, a first random number, an identifier of said request, and an identifier of a signature algorithm to be applied.

11. The equipment according to claim 10, wherein in response to an authentication request received containing the identifier of the transmitter equipment, the first random number, the identifier of the request and the identifier of the algorithm, the authentication message generated by the transmitter equipment contains a second random number, a signature and said request identifier; the signature being obtained by applying the signature algorithm corresponding to the algorithm identifier to a concatenation of the identifier of the transmitter equipment, the first random number, the identifier of the request and the second random number; and the security module is configured to verify the signature contained in an authentication message received in response to a previously sent authentication request and then determine the authentication message as valid if the signature is correct, and as invalid if the signature is incorrect, respectively.

12. An avionics communication installation configured to be embedded onboard an aircraft, the installation comprising a plurality of electronic avionics equipment interconnected, wherein at least one equipment is according to claim 1.
